(19) United States
(12) Patent Application Publication
(10) Pub. No.: US 2024/0380032 A1
(43) Pub. Date: Nov. 14, 2024

(54) Battery Cell

(71) Applicant: BAYERISCHE MOTOREN WERKE AKTIENGESELLSCHAFT, MUENCHEN (DE)

(72) Inventors: Christoph BORN, Muenchen (DE); Franz FUCHS, Muenchen (DE); Kevin GALLAGHER, Naperville, IL (US); Martin HILLER, Karlsfeld (DE); Frederik MORGENSTERN, San Francisco, CA (US); Seokyoon YOO, Muenchen (DE)

(21) Appl. No.: 18/559,850

(22) PCT Filed: May 4, 2022
(86) PCT No.: PCT/EP2022/061993

§ 371 Date: Nov. 9, 2023

(51) Int. Cl. H01M 50/107; H01M 50/317; H01M 50/559; H01M 50/567

(52) U.S. Cl. CPC H01M 50/107; H01M 50/317; H01M 50/559; H01M 50/567

(57) ABSTRACT

A battery cell is provided. The battery cell has a cell housing with an electrically conductive hollow cylinder; an electrically conductive first end plate closing off the hollow cylinder at one of the end faces thereof; at least one electrode of a first electrical polarity and at least one electrode of a second electrical polarity opposite to the first polarity, and in which the electrodes of different polarities being separated from each other by at least one separator; a first electrically conductive intermediate plate which is arranged between the first end plate and the electrodes and which is electrically insulated from the hollow cylinder; and a connecting element which is electrically connected to the first intermediate plate and the first end plate, the connecting element extending in a straight line between the first intermediate plate and the first end plate.

### BACKGROUND AND SUMMARY

The present invention relates to a battery cell.

Cylindrical, prismatic, and pouch-shaped battery cells are known in the field of battery cells, in particular lithium-ion battery cells.

In cylindrical battery cells, in particular coiled electrodes can be installed in a cylindrical housing. The electrode ends can be connected here to electrically conductive tabs, often designated as “current collectors”, using which an electrical connection to the cell exterior can be established, so that the electrical voltage of the battery can be tapped from the outside. The respective tab represents an electrical connection here of these homopolar electrodes in each case to a component of the battery cell which is electrically connected to the housing cover. Furthermore, it is known that lithium-ion cells can include a liquid electrolyte. This electrolyte is typically poured into the cell housing before it is closed. Accordingly, in known solutions the electrical connection between the one tab and the cover is formed before the filling of the electrolyte. The component which electrically connects the tab and the housing cover to one another thus has to be designed so that an electrical connection is possible both already when the cover is still open and also thereafter when it is closed. For this purpose, using a bendable metal strip as a component, which acts as a flexible hinge and has a greater opening angle in the open state of the battery cell than in the closed state is known. Due to the additional length which the metal strip reserves in order to maintain the electrical connection in the open and closed state of the battery cell, the metal strip typically has an elevated electrical resistance and a significant space requirement.

The present invention is based on the object of providing a cylindrical battery cell having a structure improved over the prior art.

This object is achieved according to the teaching of the independent claim(s). Various embodiments and refinements of the invention are the subject matter of the dependent claims.

The invention relates to a battery cell including: (i) a cell housing having an electrically conductive hollow cylinder; (ii) an electrically conductive first end plate closing off the hollow cylinder at one of its end faces; (iii) at least one electrode of a first electrical polarity and at least one electrode of a second electrical polarity opposite to the first polarity, wherein the electrodes of different polarity are separated from one another by at least one separator; and (iv) an electrically conductive first intermediate plate, which is arranged between the first end plate and the electrodes and is electrically insulated from the hollow cylinder; and (v) a connecting element, which is electrically connected to the first intermediate plate and the first end plate, wherein the connecting element extends in a straight line, i.e., in particular without a loop, between the first intermediate plate and the first end plate. In particular, the connecting element can extend between the first intermediate plate and the first end plate in a straight line along a direction which coincides with the axis of symmetry of the hollow cylinder or, at least essentially, extends parallel thereto. The at least one electrode of the first polarity is electrically connected here to the hollow cylinder. The at least one electrode of the second polarity is electrically connected to the first intermediate plate and the first end plate is electrically insulated from the hollow cylinder.

Due to a straight-line extension of the connecting element, the connecting section between the first intermediate plate and the first end plate is minimized, by which the electrical resistance of the connecting element is reduced in comparison to a longer connecting section, for example, a curved section. The space required for the intermediate element can also be kept small, which can in particular be used to increase the energy density of the cell or to reduce the structural size of the cell with equal performance or equal energy content.

The terms, which are used herein, “comprises”, “contains”, “encloses”, “includes”, “has”, “having”, or any other variant thereof are to cover a nonexclusive incorporation. Thus, for example, a method or a device which comprises or includes a list of elements is not necessarily restricted to these elements, but can contain other elements, which are not expressly listed or which are inherent to such a method or such a device.

Furthermore, “or”, if not expressly indicated to the contrary, relates to an inclusive or and not to an exclusive “or”. For example, a condition A or B is met by one of the following conditions: A is met (or present) and B is unmet (or not present), A is unmet (or not present) and B is met (or present), and both A and B are met (or present).

The terms “a” or “one” as used herein are defined in the meaning of “a/one or more”. The terms “another” and “a further” and any other variant thereof are to be understood in the meaning of “at least one further”.

“Electrical conductivity” or “electrically conductive” (and modifications thereof) is to be understood in the meaning of the invention in particular as a physical dimension which indicates how strong the capability of a material is to conduct electric current. “Electrically conductive” in the meaning of the invention is accordingly in particular to be understood as an electrical conductivity which (at 25° C.) is at least 106 S/m, thus at least corresponds to the conductivity of metals.

“Electrical insulation”, “electrically insulated” (and modifications thereof) is to be understood in the meaning of the invention in particular as a physical dimension which indicates how a specific body used as an insulator at least substantially prevents a current flow upon application of an electrical voltage. In particular, materials or bodies, the electrical conductivity of which is less than 10⁻⁸ S/cm or which have a specific resistance of greater than 108 Ω·cm, are designated as (electrical) insulators or (electrically) insulating.

Preferred embodiments of the battery cell are described hereinafter, which can each, if not expressly precluded or technically impossible, be combined with one another and with other described aspects of the invention as desired.

The at least one electrode of the first electrical polarity, the at least one electrode of the second electrical polarity, and the at least one separator can be integrated into an electrode coil. The cell housing and/or the first end plate can comprise aluminum. The separator can comprise plastic.

According to some embodiments, the first end plate includes an opening in which the connecting element engages. Direct electrical contacting of the connecting element from outside the cell housing is thus possible. It is thus possible to avoid the electric current otherwise having to overcome an electrical interface between the connecting element and the end plate, which would generally increase the electrical resistance.

According to some embodiments, the connecting element includes a cavity having an outer opening and an inner opening, wherein the cavity extends between the outer opening and the inner opening, wherein the outer opening is accessible from the opening of the first end plate. When the end plate is already installed, an electrolyte can thus be poured, for example, through the opening of the first end plate and furthermore through the cavity of the connecting element into the battery cell.

According to some embodiments, the cross section of the connecting element is enlarged from the outer opening toward the inner opening. The cross section can be enlarged in steps, and the cross section can be formed circular or ellipsoidal. The opening of the first end plate for filling with the electrolyte is typically kept small, and is sealed closed after the filling. The electrolyte is to distribute itself in the electrode coil. Therefore, it can be advantageous if the cross-sectional area expands from the opening toward the electrodes, since the electrolyte already distributes itself over an expanding cross section here.

According to some embodiments, the battery cell includes a second end plate, which is arranged opposite to the first end plate on another end face of the hollow cylinder, wherein the second end plate includes a gas outlet mechanism. A possibly occurring overpressure in the battery cell can thus be dissipated. For example, in case of a fault, in which a short-circuit occurs inside the battery cell, a gas could arise inside the battery cell which can be discharged from the battery using the gas outlet mechanism.

According to some embodiments, the gas outlet mechanism includes a valve, in particular an overpressure valve. The pressure at which the valve opens can be determined beforehand by the selection of a suitable valve. It is thus possible to prevent the pressure in the battery cell from rising above the previously determined pressure. This contributes to the additionally safer use of the battery cell.

According to some embodiments, the gas outlet mechanism in the second end plate is formed as an intended breakpoint, so that a region can be broken out of the second end plate under the action of a mechanical force along the cylinder axis. This means that the thickness of the second end plate is reduced at selected points, for example, by material removal, so that the end plate breaks at this point due to the action of a force. The material removal can take place so that in this way an area is enclosed, for example, by a circumferential groove, which breaks out in the event of a force action. The intended breakpoint can possibly also be formed on the end plate after the installation of the end plate, thus on the fully assembled battery cell. An additional component is not required. This solution is insofar inexpensive and simple to implement.

According to some embodiments, the battery cell includes a second intermediate plate, which is arranged between the at least one electrode of the first polarity and the second end plate, and wherein the second intermediate plate is electrically connected in each case to the at least one electrode of the first polarity and the hollow cylinder. The electrical second pole can thus be contacted via the cell housing, by which an electrical connection within the housing from the second intermediate plate to the first end plate is avoided, which would be associated with additional constructive expenditure.

According to some embodiments, the first end plate is connected in a form fitting manner to the hollow cylinder and an electrically insulating layer arranged between the first end plate and the hollow cylinder. The first end plate is thus connected in a form fitting manner to the hollow cylinder and the electrically insulating layer and a short-circuit between the hollow cylinder and the first end plate is avoided at the same time.

According to some embodiments, the connecting element includes a rivet, which is arranged in the opening of the first end plate, and forms a form fitting connection with the first end plate and an electrically insulating layer arranged between the first end plate and the rivet. The rivet enables a stable mechanical connection and at the same time an electrical connection to the first intermediate plate, which is connected to the electrodes of the first polarity, so that an electrical connection from outside the cell housing to the electrodes of the first polarity is formed by the rivet.

Further advantages, features, and possible applications of the present invention result from the following detailed description in conjunction with the figures.

### BRIEF DESCRIPTION OF THE DRAWINGS

FIG. 1 is a schematic illustration of a battery cell according to a first exemplary embodiment.

FIG. 2 is a schematic illustration of a battery cell according to a second exemplary embodiment.

FIG. 3 is a schematic illustration of the underside of the battery cell according to FIG. 1 and FIG. 2.

In the figures, the same reference signs are used throughout for the same or corresponding elements of the invention.

### DETAILED DESCRIPTION OF THE DRAWINGS

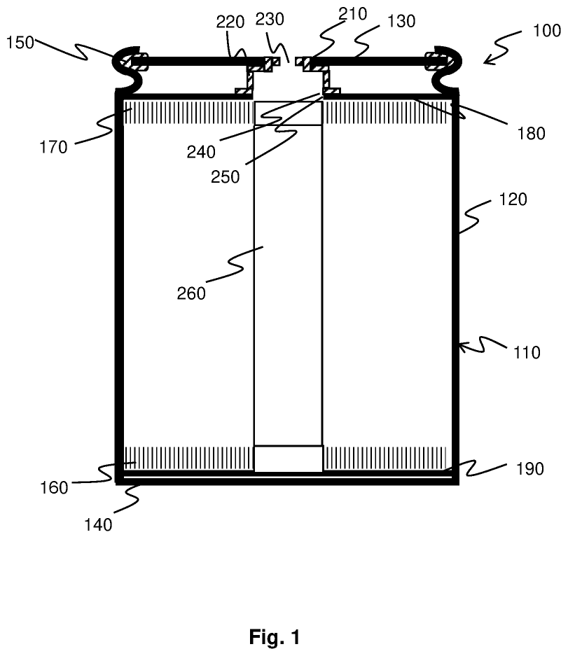

FIG. 1 schematically shows a battery cell 100 according to a first exemplary embodiment. The battery cell 100 includes a cell housing 110 having an electrically conductive hollow cylinder 120, wherein a first electrically conductive end plate 130 and a second electrically conductive end plate 140 are each arranged opposite on the two end faces of the hollow cylinder 120. The first end plate 130 is arranged in a circularly extending groove, wherein a first electrically insulating element 150 is arranged between the first end plate 130 and the groove, which electrically insulates the first end plate 130 in relation to the hollow cylinder 120. The opening of the groove is directed here toward the cylinder axis of the hollow cylinder 120. The hollow cylinder 120 has a circular cross section. The first end plate 130 is formed circular, but an end plate 130 having an ellipse shape is also conceivable, in particular if the cross section of the hollow cylinder 120 has an ellipse shape.

An electrode coil (not shown here) is arranged in the cell housing 110. The electrode coil includes electrodes having a first, for example negative, polarity 160, and electrodes having a second, accordingly positive, polarity 170, wherein electrodes of the first polarity 160 and electrodes of the second polarity 170 are arranged alternately in the radial direction. A separator is arranged in each case between the electrodes of first and second polarity 160, 170, so that the electrodes of different polarity are electrically insulated from one another, wherein the separator includes an electrically insulating material.

The electrodes of the second polarity 170 are electrically connected to a first electrically conductive intermediate plate 180, which can be a circular metal plate, for example, made of aluminum or copper. The first intermediate plate 180 is arranged between the first end plate 130 and the electrodes of the second polarity 170, and is fastened on the hollow cylinder 120, to which the intermediate plate 180 is attached in an electrically insulating manner.

The first intermediate plate 180 includes a circular recess 250, which is arranged in the center of the surface of the intermediate plate 180, so that the cylinder axis extends through the opening 250.

A projection 220 functioning as a connecting element, which is electrically connected to the first end plate 130 and the first intermediate plate 180, is arranged between the first end plate 130 and the first intermediate plate 180. The projection 220 is formed symmetrical to the cylinder axis and includes a through cavity, which extends from an outer opening 230 axially along the cylinder axis up to an inner opening 240. The projection 220 engages in the opening 210 of the first end plate 130, so that the outer opening 230 is inside the opening 210 of the first end plate, and the opening 210 of the first end plate 130 is reduced in size by the edge region of the outer opening 230. The inner opening 240 directly axially adjoins the recess 250. This arrangement of the projection 220 enables an electrolyte to be able to be poured into the battery cell 110 through the opening 210 and the outer opening 230, and through the cavity of the projection. The first end plate 130 is installed in a formfitting manner in this case.

The opening 210 of the end plate 130 and the recess 250 of the first intermediate plate 180 are arranged axially in relation to one another with respect to the cylinder axis so that an electrolyte which is poured through the opening 210 through the cavity of the projection 220 finally reaches the electrode coil through the recess 250.

The projection 220 enables the filling of the battery cell 100 with an electrolyte, wherein the first end plate 130 is already installed. Moreover, a direct and straight-line electrical connection between the first intermediate plate 180 and the first end plate 130 is established by the projection 220.

The electrodes of the first polarity 160 are electrically connected to a second electrically conductive intermediate plate 190, which can be a metal plate, which can comprise copper. The second electrical intermediate plate 190 is electrically connected to the second end plate 140, and thus to the hollow cylinder 120. A mandrel 260 is arranged along the cylinder axis between the first intermediate plate 180 and the second intermediate plate 190.

The second end plate 140 furthermore includes a circular groove, so that a circular region 300 can be broken out of the second end plate 310 under the action of a mechanical force along the cylinder axis. This force can have occurred due to an overpressure of a gas arising in the battery cell, which can have been induced by a short circuit.

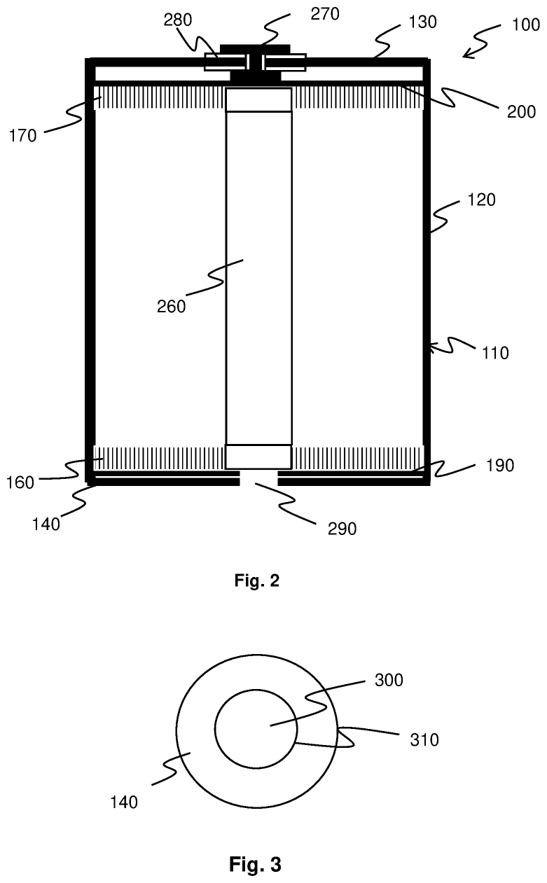

FIG. 2 schematically shows a battery cell 100 according to a second exemplary embodiment. The battery cell 100 includes a cell housing 110 having an electrically conductive hollow cylinder 120, wherein a first electrically conductive end plate 130 and a second electrically conductive end plate 140 are each arranged opposite on the two end faces of the hollow cylinder 120. The first end plate 130 is arranged in a circularly extending groove, wherein a first electrically insulating element 150, which electrically insulates the first end plate 130 in relation to the hollow cylinder 120, is arranged between the first end plate 130 and the groove. The opening of the groove is directed toward the cylinder axis of the hollow cylinder 120 here. The hollow cylinder 120 has a circular cross section. The first end plate 130 is formed circular, but an end plate 130 having an ellipse shape is also conceivable, in particular if the cross section of the hollow cylinder 120 has an ellipse shape.

An electrode coil (not shown here) is arranged in the cell housing 110. The electrode coil includes electrodes having a first, for example negative, polarity 160, and electrodes having a second, accordingly positive, polarity 170, for example, wherein electrodes of the first polarity 160 and electrodes of the second polarity 170 are arranged alternately in the radial direction. A separator is arranged in each case between the electrodes of first and second polarity 160, 170, so that the electrodes of different polarity are electrically insulated from one another, wherein the separator includes an electrically insulating material.

The electrodes of the second polarity 170 are electrically connected to a first electrically conductive intermediate plate 180, which can be a circular metal plate, for example, made of aluminum or copper. The first intermediate plate 180 is arranged between the first end plate 130 and the electrodes of the second polarity 170, and is fastened on the hollow cylinder 120, to which the intermediate plate 180 is attached in an electrically insulating manner.

The electrodes of the first polarity 160 are electrically connected to a second electrically conductive intermediate plate 190, which can be a circular metal plate which can comprise copper. The second electrical intermediate plate 190 is electrically connected to the second end plate 140, and thus to the hollow cylinder 120.

The first end plate 130 furthermore includes a circular opening 210, which is arranged in the center of the surface of the first end plate 130. A rivet 270 functioning as a connecting element is arranged in the opening, which is electrically insulated by an electrically insulating layer 280 from the first end plate 130. The rivet 270 forms a formfitting connection with the electrically insulating layer 280 and the first end plate 130. The rivet 270 is electrically connected to a third electrical intermediate plate 200. The electrodes of the second polarity 170 are thus electrically connected to the rivet 270.

The second end plate 140 furthermore includes a circular groove, so that under the action of a mechanical force along the cylinder axis, a circular region 300 can be broken out of the second end plate 310. This force can have occurred due to an overpressure of a gas arising in the battery cell, which can have been induced by a short circuit.

The second end plate 140 furthermore includes a closable electrolyte access 290, which extends through the second end plate 140 in the second intermediate plate 190, so that an electrolyte can be poured into the battery cell 110.

Due to this arrangement, the electrical connections of the electrodes of the second polarity 170 are arranged on the opposite side of the electrolyte access.

FIG. 3 schematically shows the underside of the battery cell 100 according to FIG. 1 and FIG. 2. The second end plate 140 includes a circular groove, so that under the action of a mechanical force along the cylinder axis, a circular region 300 can be broken out of the second end plate 310, and gas can escape from the interior of the battery cell.

It is also conceivable that the first end plate 130 includes an electrolyte access and/or gas outlet mechanism. It is also conceivable that the first end plate 130 includes one of the group electrolyte access or gas outlet mechanism and the second end plate 140 includes the other of the group electrolyte access or gas outlet mechanism. Furthermore, it is also conceivable that the first end plate 130 and the second end plate 140 each do not have either of the group electrolyte access and gas outlet mechanism.

While at least one exemplary embodiment was described above, it is to be noted that a large number of variations thereto exists. It is also to be noted in this case that the described exemplary embodiments only represent nonlimiting examples, and it is not intended that the scope, the applicability, or the configuration of the devices and methods described here be restricted thereby. Rather, the preceding description will provide a person skilled in the art with guidance to the implementation of at least one exemplary embodiment, wherein it is apparent that various changes in the functionality and the arrangement of the elements described in one exemplary embodiment can be performed, without deviating here from the subject matter defined in each of the appended claims and its legal equivalents.

### LIST OF REFERENCE NUMERALS

100 Battery cell
110 Cell housing
120 Hollow cylinder
130 First end plate
140 Second end plate
150 First electrically insulating element
160 Electrodes of the first polarity
170 Electrodes of the second polarity
180 First intermediate plate
190 Second intermediate plate
200 Third intermediate plate
210 Opening
220 Projection
230 Outer opening
240 Inner opening
250 Recess
260 Mandrel
270 Rivet
280 Electrically insulating layer
290 Electrolyte access
300 Circular region
310 Circular groove

1.-10. (canceled)

11. A battery cell, comprising:
a cell housing having an electrically conductive hollow cylinder;
an electrically conductive first end plate closing the hollow cylinder on one of its end faces;
at least one electrode of a first electrical polarity and at least one electrode of a second electrical polarity, opposite to the first polarity, wherein the electrodes of different polarities are separated from one another by at least one separator;
an electrically conductive first intermediate plate, which is arranged between the first end plate and the electrodes and is electrically insulated from the hollow cylinder; and
a connecting element, which is electrically connected to the first intermediate plate and the first end plate, and wherein the connecting element extends in a straight line between the first intermediate plate and the first end plate;
wherein:
the at least one electrode of the first polarity is electrically connected to the hollow cylinder;
the at least one electrode of the second polarity is electrically connected to the first intermediate plate; and
the first end plate is electrically insulated from the hollow cylinder.

12. The battery cell according to claim 11, wherein
the first end plate includes an opening, in which the connecting element engages.

13. The battery cell according to claim 11, wherein
the connecting element includes a cavity having an outer opening and an inner opening, wherein the cavity extends between the outer opening and the inner opening, wherein the outer opening is accessible from the opening of the first end plate.

14. The battery cell according to claim 11, wherein
the cross section of the connecting element enlarges from the outer opening toward the inner opening.

15. The battery cell according to claim 11, further comprising:
a second end plate, which is arranged opposite to the first end plate on another end face of the hollow cylinder, wherein the second end plate includes a gas outlet mechanism.

16. The battery cell according to claim 15, wherein
the gas outlet mechanism includes a valve.

17. The battery cell according to claim 16, wherein
the gas outlet mechanism in the second end plate is designed as an intended breakpoint, so that a region can be broken out of the second end plate under the action of a mechanical force along the cylinder axis.

18. The battery cell according to claim 15, further comprising:
a second intermediate plate, which is arranged between the at least one electrode of the first polarity and the second end plate, and wherein the second intermediate plate is electrically connected in each case to the at least one electrode of the first polarity and the hollow cylinder.

19. The battery cell according to claim 11, wherein
the first end plate is connected in a form fitting manner to the hollow cylinder and an electrically insulating element arranged between the first end plate and the hollow cylinder.

20. The battery cell according to claim 15, wherein
the connecting element includes a rivet, which is arranged in the opening of the first end plate, and forms a form fitting connection with the first end plate and an electrically insulating layer arranged between the first end plate and the rivet.
